(19) United States
(12) Patent Application Publication
(10) Pub. No.: US 2025/0003518 A1
(43) Pub. Date: Jan. 2, 2025

(54) Electromagnetic Check Valve with a Deformable Ferromagnetic Plugging Element for Fluid Flow Control

(71) Applicant: Jefferey Raymond Gutterud, Vista, CA (US)

(72) Inventor: Jefferey Raymond Gutterud, Vista, CA (US)

(21) Appl. No.: 18/215,967

(22) Filed: Jun. 29, 2023

(51) Int. Cl. F16K 31/06; F16K 15/18

(52) U.S. Cl. CPC F16K 31/0675; F16K 15/1823

(57) ABSTRACT

The invention disclosed herein relates to an electromagnetic check valve designed for controlling fluid flow. The valve incorporates a deformable ferromagnetic plugging element that seals an opening as a default state. Upon the activation of an electromagnet, the ferromagnetic plugging element is moved, unsealing the opening and allowing fluid to flow. Upon the deactivation of the electromagnet, gravity or a hydrostatic pressure difference causes the ferromagnetic plugging element to move back and reseal the opening. The invention enhances the reliability and efficiency of fluid control systems by reducing the need for mechanical actuation and constant human intervention, while operating effectively across a broad range of fluid pressures.

### FIELD OF INVENTION

The present invention relates generally to a The present invention relates generally to the field of fluid control valves. More particularly, the invention pertains to an electromagnetic check valve that regulates fluid flow through an opening, using a deformable ferromagnetic plugging element that automatically re-seals the opening when the electromagnet is deactivated, leveraging gravity and/or hydrostatic pressure.

### BACKGROUND

Fluid control valves are fundamental components in numerous applications, including water distribution systems, hydraulic control systems, fluid flow in scientific instrumentation, and more. The performance of these systems often hinges on the efficiency and reliability of their control valves. Traditional valves regulate fluid flow by transitioning between open and closed states, typically via manual control or automatic response to changes in pressure or temperature.

However, several inherent limitations mar conventional valves. First, manual operation often necessitates constant monitoring, and changes in fluid flow conditions require immediate adjustment, introducing an element of human error. Additionally, automated valves generally rely on mechanical actuators, springs, or pneumatic systems to open and close, which are subject to wear and tear over time, reducing overall reliability and increasing maintenance needs. Furthermore, such traditional systems often require energy input in both the opening and closing processes, leading to increased energy consumption.

One-way check valves, which allow fluid to flow in one direction only, address some of these concerns by using the fluid pressure itself to open and close the valve. However, existing check valves typically rely on mechanical springs or pressure differentials to return the valve to its closed state, which can be problematic. For instance, springs can lose their resilience over time, and relying on pressure differentials is not always reliable, particularly in low-pressure environments. Also, these mechanical solutions can cause noise, vibration, and in some cases, a slower response time to changing fluid dynamics.

Solenoid valves, a specific type of electromechanically operated valve, also exist. They typically use an electromagnetic solenoid to lift a plunger and allow fluid to flow. Nevertheless, conventional solenoid valves also have their drawbacks. They generally consume power continuously during the open state and require an actuator mechanism to close the valve, contributing to energy inefficiency. Moreover, like other traditional valves, solenoid valves involve moving parts susceptible to wear and tear, potentially impacting their reliability and lifespan.

Considering the limitations of existing valve systems, there is a pressing need for a more reliable, energy-efficient, and swift fluid control mechanism. Such a solution should minimize mechanical wear, eliminate the need for constant human intervention, and work efficiently across a range of pressure conditions.

It is within this context that the present invention is provided.

### SUMMARY

The present invention overcomes the limitations of the prior art by providing an electromagnetic check valve configured to control fluid flow through an opening. In its essence, the invention employs a deformable ferromagnetic plugging element that seals the opening as a default state and opens the valve by energizing the electromagnet, causing the plugging element to move and break the seal. When the electromagnet is deactivated, natural forces such as gravity and hydrostatic pressure differences allow the plugging element to reposition itself and re-seal the opening, thereby closing the valve.

In one embodiment of the invention, a solenoid with a ferromagnetic iron core, which is coupled to or part of the plugging element, is used. The iron core is arranged within a fluid outlet tube and is attached to an umbrella valve with a deformable umbrella that covers the aperture of the outlet. When the electromagnetic coil of the solenoid is energized, the iron core moves out of the outlet, pushing the deformable umbrella away from the aperture, and allowing fluid to flow into the outlet. When the coil is not energized, the umbrella is pushed back against the aperture due to the weight of the iron core and the hydrostatic pressure. The umbrella then deforms to create a seal.

In another embodiment, a ferromagnetic ball, which may be coated in silicone, is used as the plugging element. The ball sits within an open-ended cone, sealing the cone's open end due to its weight. When an electromagnet, positioned to the side of the ball, is energized, the ferromagnetic ball is displaced, allowing fluid to flow out of the cone's open end. Once the electromagnet is de-energized, the weight and shape of the ball cause it to roll back into position, thereby re-sealing the cone aperture.

These and other advantages of the present invention will become apparent upon reading the following detailed descriptions and studying the various figures of the drawings.

The present invention provides a simplified and energy-efficient solution to fluid control, with minimal moving parts and reduced maintenance needs, thereby enhancing the lifespan and reliability of the system. The invention operates efficiently across a broad range of fluid pressures, reducing the need for constant human intervention and complex mechanical actuation. The embodiments highlighted are illustrative and are not meant to be exhaustive of all possible configurations of the invention.

### BRIEF DESCRIPTION OF THE DRAWINGS

Various embodiments of the invention are disclosed in the following detailed description and accompanying drawings.

FIG. 1 shows a cross-sectional view of the first embodiment of the electromagnetic check valve, depicting the valve in a default, closed position. The electromagnetic coil is in a non-energized state, with a deformable umbrella coupled to a ferromagnetic iron core, forming a seal around an outlet aperture.

FIG. 2 illustrates the same first embodiment of the valve as FIG. 1, but in an open position. The electromagnetic coil is in an energized state, causing the ferromagnetic iron core and attached deformable umbrella to move upward and away from the outlet aperture, breaking the seal and allowing fluid to flow through the outlet aperture.

FIG. 3 presents a cross-sectional view of the second embodiment of the valve, which uses a different configuration. In its default, closed position, a ferromagnetic ball is resting at the bottom of an open-ended cone structure, blocking an aperture. The electromagnets situated in the walls of the cone structure are in a non-energized state.

FIG. 4 depicts the second embodiment of the valve as in FIG. 3, but in an open position. The electromagnets are energized, generating a magnetic field that displaces the ferromagnetic ball, causing it to roll up along the inner wall of the cone structure and unblock the aperture, thus allowing fluid flow.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terminology used herein is for the purpose of describing particular embodiments only and is not intended to be limiting.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DESCRIPTION OF DRAWINGS

In accordance with the present invention, an electromagnetic check valve is provided for controlling fluid flow. As described herein, the valve utilizes a deformable ferromagnetic plugging element that seals an opening as a default state, and upon energizing an electromagnet, causes the plugging element to move, thereby unsealing the opening and allowing fluid to flow. When the electromagnet is deactivated, gravity or a hydrostatic pressure difference allows the plugging element to reposition itself and reseal the opening.

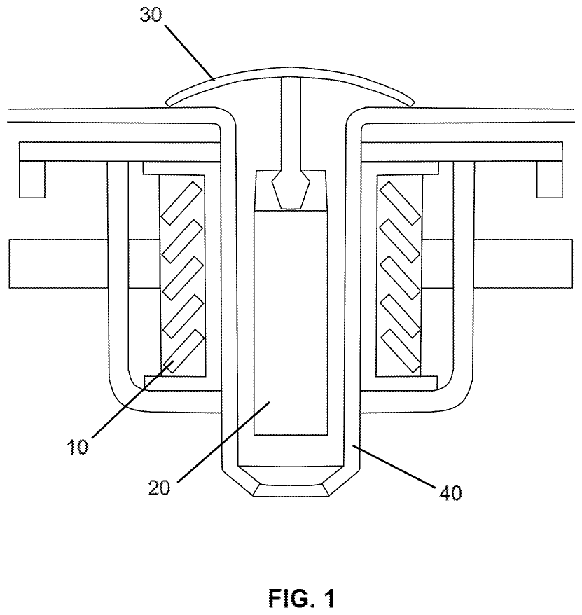

As shown in FIG. 1, the valve assembly comprises an electromagnetic coil (10), a ferromagnetic iron core (20), and a deformable umbrella (30). The ferromagnetic iron core (20) is coupled to or forms a part of the deformable umbrella (30) which serves as the plugging element.

The electromagnetic coil (10) is configured to surround a portion of a fluid outlet tube (40) which contains the iron core (20). The electromagnetic coil (10) is shown in a non-energized state in FIG. 1, corresponding to the closed position of the valve.

The iron core (20) is positioned in a low position within the fluid outlet tube (40). This is the default position of the iron core (20) when the electromagnetic coil (10) is not energized, and it serves to exert a downward force on the deformable umbrella (30). In this configuration, the valve leverages the weight of the iron core and the potential hydrostatic pressure differences to keep the valve in a closed state when the electromagnetic coil is not energized. It can be appreciated that the weight of the iron core and any prevailing hydrostatic pressure act in the same direction to create a seal around the outlet aperture with the umbrella. This arrangement also provides an energy-efficient means of maintaining the valve in a closed position, as no additional energy input is required to sustain the seal.

The deformable umbrella (30) is shown in FIG. 1 as covering an aperture of the outlet tube (40). The deformable umbrella (30) conforms to the shape of the aperture to form a seal when the iron core (20) is in the low position. The sealing of the aperture prevents fluid from passing through the outlet tube (40), thereby maintaining the valve in a closed state.

The interaction between the weight of the iron core (20) and the hydrostatic pressure differences, as well as the deformability of the umbrella (30), ensures a robust seal formation that prevents any fluid leakages. This robust sealing mechanism is maintained even when the electromagnetic coil (10) is not energized, ensuring energy-efficient operation of the valve.

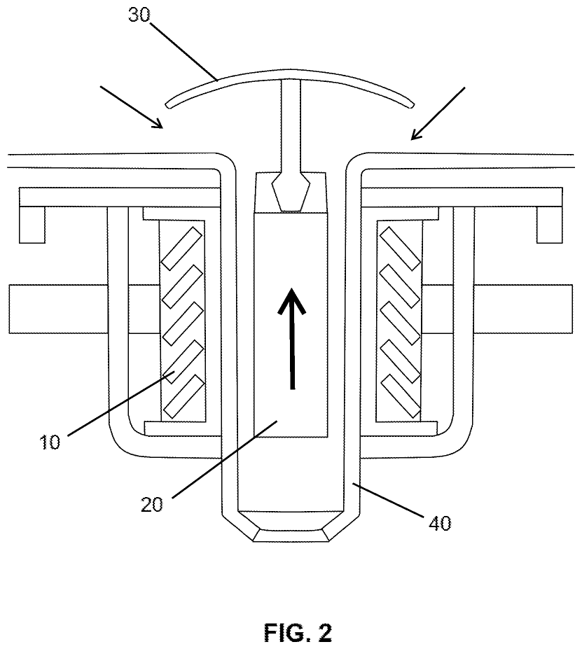

Turning now to FIG. 2, a cross-sectional view of the first example of the valve is presented in an open position.

In contrast to FIG. 1, in FIG. 2, the electromagnetic coil (10) is in an energized state. When the electromagnetic coil (10) is energized, it creates a magnetic field that induces movement in the ferromagnetic iron core (20). This magnetic field forces the iron core (20) to move in an upward direction, away from its default low position.

As the iron core (20) moves upward, it pushes the deformable umbrella (30) away from the aperture of the outlet tube (40). The upward movement of the iron core (20) causes the deformable umbrella (30) to unfold and move out of the outlet aperture, effectively breaking the seal that was formed in the closed state.

With the seal broken, fluid is allowed to pass through the aperture of the outlet tube (40). As such, the energizing of the electromagnetic coil (10) transitions the valve from its closed state (as depicted in FIG. 1) to an open state (as depicted in FIG. 2). This transition allows for the control of fluid flow through the outlet tube (40), achieving the operational objective of the electromagnetic check valve.

Once the electromagnetic coil (10) is de-energized, gravity and hydrostatic pressure differences work in concert to return the iron core (20) and the attached deformable umbrella (30) to their default positions, thereby resealing the outlet aperture and returning the valve to its closed state.

In both FIG. 1 and FIG. 2, the valve is presented in a vertical arrangement. However, it should be noted that the orientation of the valve in use may vary depending on the specific application. The efficacy of the valve is not constrained by its orientation due to the combination of the weight of the plugging element and the hydrostatic pressure differences which ensure the sealing and unsealing actions.

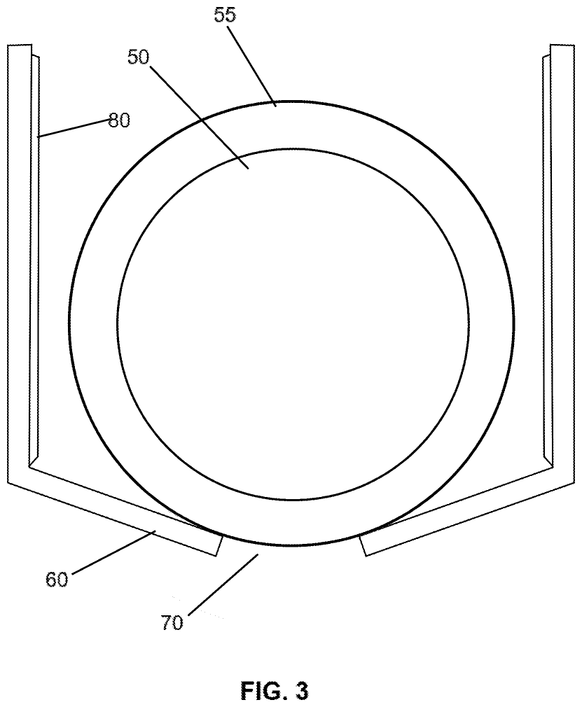

In FIG. 3, a different configuration of the valve is depicted, where the plugging element is a ferromagnetic ball (50) with a silicone coating (55), situated at the bottom of an open-ended cone structure (60). The ball (50) is precisely sized to cover and seal an aperture (70) located at the bottom of the cone structure (60). The weight of the ferromagnetic ball (50) and the shape of the cone structure (60) ensure that the ball (50) naturally rests in a position covering the aperture (70), thereby sealing it and preventing fluid flow.

The walls of the cone structure (60) house multiple electromagnets (80), which are shown in a de-energized state in FIG. 3. These electromagnets (80) are positioned in such a way that they can exert a lateral force on the ferromagnetic ball (50) when energized. However, in their de-energized state, as depicted in FIG. 3, the electromagnets (80) exert no force on the ball (50), leaving it to rest at the bottom of the cone structure (60) and block the aperture (70). This effectively maintains the valve in a closed position, with the ball (50) forming a seal over the aperture (70).

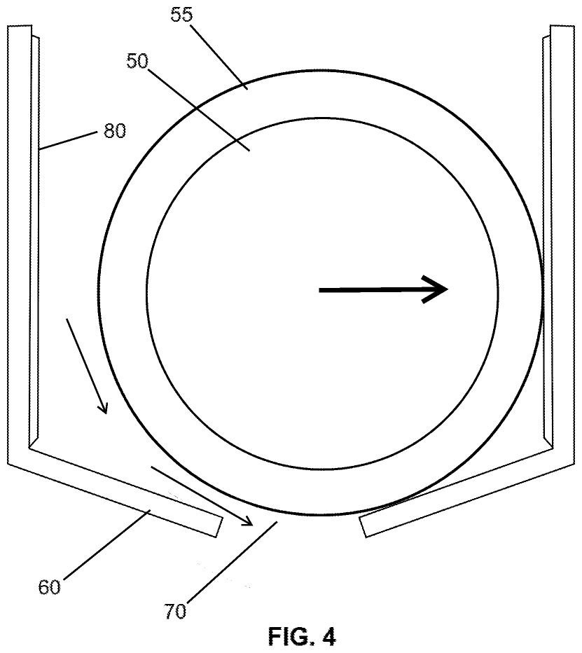

Moving on to FIG. 4, the same valve configuration as in FIG. 3 is shown, but in this figure, the electromagnets (80) are in an energized state. When the electromagnets (80) are energized, they generate a magnetic field that acts on the ferromagnetic ball (50), causing it to roll up along the inner wall of the cone structure (60). This movement displaces the ball (50) from the bottom of the cone structure (60), unblocking the aperture (70).

The displacement of the ferromagnetic ball (50) breaks the seal over the aperture (70), transitioning the valve to an open position and allowing fluid to flow through the aperture (70). Once the electromagnets (80) are de-energized, the weight of the ball (50) and the shape of the cone structure (60) work together to return the ball (50) to its default position, resealing the aperture (70) and returning the valve to its closed state.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the check valve have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An electromagnetic check valve for controlling fluid flow comprising:
a deformable ferromagnetic plugging element arranged to seal an opening of a fluid outlet as a default state;
an electromagnet operable to be energized to cause said ferromagnetic plugging element to move and unseal said opening, thereby allowing fluid to flow through said opening;
wherein said ferromagnetic plugging element is arranged to move back and reseal said opening under the influence of gravity or a hydrostatic pressure difference when said electromagnet is deactivated.

2. The electromagnetic check valve of claim 1, wherein said ferromagnetic plugging element is an iron core of a solenoid.

3. The electromagnetic check valve of claim 2, wherein said iron core is coupled with a deformable umbrella valve that covers the aperture of the fluid outlet.

4. The electromagnetic check valve of claim 3, wherein said deformable umbrella valve is made of silicone.

5. The electromagnetic check valve of claim 2, wherein said solenoid further comprises an electromagnetic coil surrounding a portion of said fluid outlet containing said iron core.

6. The electromagnetic check valve of claim 1, wherein said ferromagnetic plugging element is a ferromagnetic ball arranged to sit within an open-ended cone, sealing the open end of said cone due to its weight.

7. The electromagnetic check valve of claim 6, wherein said ferromagnetic ball is coated in silicone.

8. The electromagnetic check valve of claim 6, wherein an electromagnet is positioned to the side of said ferromagnetic ball, such that when said electromagnet is energized, said ferromagnetic ball is displaced, allowing fluid to flow out of said open-ended cone.

9. The electromagnetic check valve of claim 1, wherein the fluid flow is a liquid flow and the resealing of the opening by the ferromagnetic plugging element is facilitated by hydrostatic pressure differences on either side of said opening.

10. The electromagnetic check valve of claim 1, wherein the fluid flow is a gas flow and the resealing of the opening by the ferromagnetic plugging element is facilitated by pressure differences on either side of said opening.

11. The electromagnetic check valve of claim 1, wherein the movement of the ferromagnetic plugging element to unseal the opening is against the direction of gravity.

12. The electromagnetic check valve of claim 1, further comprising a control mechanism operatively connected to said electromagnet to regulate the activation and deactivation of said electromagnet.

13. The electromagnetic check valve of claim 1, wherein said electromagnet, upon being deactivated, does not contribute to the resealing of said opening by the ferromagnetic plugging element.
